(19) United States
(12) Patent Application Publication
(10) Pub. No.: US 2005/0195489 A1
(43) Pub. Date: Sep. 8, 2005

(54) Lens, transmission screen, and method for manufacturing the lens

(75) Inventors: Kenichi Watabe, Niigata (JP); Hiroyuki Shimotsuma, Niigata (JP); Shinichi Imai, Niigata (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/071,645

(22) Filed: Mar. 3, 2005

Related U.S. Application Data
(60) Provisional application No. 60/550,559, filed on Mar. 5, 2004.

(51) Int. Cl. G02B 3/00

(52) U.S. Cl. 359/642

(57) ABSTRACT

A lens which has a plurality of protrusions and cavities includes a core layer having a cross sectional shape smaller than and similar to a cross sectional shape of the lens; and a skin layer, which covers the core layer, having a smaller storage modulus of elasticity than that of said core layer. The lens may further include a substrate for fixing the core layer on a surface thereof, the substrate having tabular shape being made of a light-transmitting material.

### BACKGROUND OF THE INVENTION

1. Field of the Invention

The present invention relates to a lens, a transmission screen, and a method for manufacturing the lens. More particularly, the present invention relates to a lens which has a plurality of protrusions and cavities, a transmission screen having the lens, and a method for manufacturing the lens.

2. Description of the Related Art

There is a problem accompanying a lens which has a plurality of protrusions and cavities, such as, a Fresnel lens and a fly-eye lens that a tip portion of the protrusion is easy to break in case the lens contacts with another member. To enhance hardness of resin forming the lens in order to solve this problem raises another problem that the tip portion of the protrusion is easy to be damaged while a shape stability of the lens is improved. Thus, a there is an approach to be compatible with the shape stability and the scratch resistance by deciding a characteristics of resin (for example, see Japanese Patent Application Laid-Open No. 2003-84101).

However, according to the conventional art above mentioned, it is difficult to satisfy both the shape stability of a lens and the scratch resistance at high levels.

### SUMMARY OF THE INVENTION

In order to overcome the above drawbacks accompanying the conventional art, according to the first aspect of the present invention, a lens which has a plurality of protrusions and cavities includes a core layer having a cross sectional shape smaller than and similar to a cross sectional shape of the lens; and a skin layer, which covers the core layer, having a smaller storage modulus of elasticity than that of said core layer. By this, it is possible to achieve a lens of both high shape stability and high scratch resistance.

The lens may further include a substrate, which has tabular shape and is made of a light transmitting material, for fixing the core layer on a surface thereof. By this, it is possible to manage the plurality of protrusions and cavities at a time during assembling and conveying.

According to the lens, thickness of the skin layer may be substantially uniform in a direction perpendicular to a bottom surface of the lens. In this case, it is possible to protect substantially uniformly the whole surface of the lens.

According to the lens, thickness of the skin layer may be thicker at closer a vertex of the lens in a direction perpendicular to a bottom surface of the lens. In this case, it is possible to protect preferentially the tip portion of the lens which is easy to contact with another member.

According to the lens, the cross sectional shape of the core and skin layers may be wedge-shaped, and a vertical angle of the wedge-shaped cross section of the core layer may be greater than that of the skin layer. By this, it is possible to enhance shape stability of the lens because the area of the lens occupied by the core layer becomes larger at nearer to the bottom surface of the lens.

The lens maybe a micro lens array including a plurality of micro lens unit cell. Since the size of single micro lens unit cell is very small, a lens function of the micro lens unit cell is easy to be seriously damaged in case the micro lens unit cell is damaged. Therefore, the above constitution of the lens is very effective especially in case of the micro lens array.

The lens may be a fly-eye lens including a plurality of micro lens unit cell disposed in a plane. With regard to the fly-eye lens, each micro lens unit cell refracts pixel light incident upon the fly-eye lens. Therefore, it is impossible to refract properly the light incident upon the micro lens unit cell if the micro lens unit cell is damaged. Thus, the above structure of the lens is very effective especially in case of the fly-eye lens.

According to the lens, the height of the core layer is greater than a half of the total height of the lens. By this, it is possible to enhance shape stability of the lens while preventing the lens from being damaged.

According to the second aspect of the present invention, a light-transmitting screen includes a lens which has a plurality of protrusions and cavities; and an optical member provided to face the plurality of protrusions and cavities on the lens, wherein the lens includes; a core layer having a cross sectional shape smaller than and similar to a cross sectional shape of the lens; and a skin layer, which covers the core layer, having a smaller storage modulus of elasticity than that of the core layer, and a storage modulus of elasticity of the optical member is greater than that of the skin layer. By this, it is possible to achieve a high scratch resistance of the lens against other optical member due to the buffer effect of the skin layer.

According to the third aspect of the present invention, a method for manufacturing a lens of which a plurality of protrusions and cavities are formed, including: a resin layer forming step of substantially uniformly forming an uncured transparent resin of a predetermined thickness on a light-transmitting substrate having tabular shape; a filling step of filling the uncured transparent resin in a mold by pressing the uncured transparent resin layer on the mold of the lens; a curing step of curing the transparent resin filled in the mold; and a releasing step of releasing the cured resin from the mold. According to the manufacturing method as above, it is possible to press the transparent resin of the amount enough and necessary for forming the lens into the mold by controlling the thickness of the transparent resin formed on the substrate. Therefore, the transparent resin is not flowed out of the mold in mold pressing, and the conventional removing process of removing excessive resin from the mold is not required.

The method for manufacturing a lens may further include a pressure reducing step of reducing ambient pressure of the mold before said filling step. By this, it is possible to fill completely in the mold with the transparent resin without generating bubbles in mold pressing.

According to the above method for manufacturing a lens, an uncured ultraviolet curable resin layer may be formed to have a predetermined thickness substantially uniformly on the substrate in the resin layer forming step, and the ultraviolet curable resin filled in the mold may be cured by ultraviolet ray irradiation thereto in the curing step. By this, it is possible to press the ultraviolet curable resins of the amount enough and necessary for forming the lens into the mold and to make the mold structure and temperature control easily. Therefore, productivity of the lens is increased.

The method for manufacturing a lens may further include a soft resin layer forming step of substantially uniformly forming an uncured transparent soft resin layer of predetermined thickness on the upper surface of the uncured transparent resin, the soft resin layer having a storage modulus of elasticity in cured status smaller than that of the transparent resin, between the resin layer forming step and filling step. By this, it is possible to simply manufacture a lens, which includes the transparent resin of which surface is covered with the soft resin.

According to the method for manufacturing a lens, the soft resin may be formed to be thinner than the transparent resin in the soft resin layer forming step. By this, it is possible to manufacture a lens of high shape stability because the major portion of it is formed of the hard transparent resin which is harder than the soft resin (hereinafter it is just referred as a hard transparent resin).

The method for manufacturing a lens may further include a step of providing the uncured transparent resin and the uncured transparent soft resin so that a loss modulus of rigidity of the uncured transparent soft resin is greater than that of the uncured transparent resin, before the soft resin layer forming step. By this, the transparent soft resin layer 40 is hard to be varied in its thickness by a shearing force from the mold during the forming process of the hard transparent resin 30 according to the shape of cavity of the mold in mold pressing. Therefore, the transparent soft resin layer is formed to have a substantially uniform thickness.

The method for manufacturing a lens may further include a step of providing the uncured transparent resin and the uncured transparent soft resin in advance in order for a loss modulus of rigidity of the uncured transparent soft resin to be smaller than that of the uncured transparent resin, before the soft resin layer forming step. By this, the transparent soft resin layer is easy to be varied in its thickness by a shearing force from the mold during the forming process of the hard transparent resinhard transparent resin according to the shape of cavity of the mold in mold pressing. As a result, the thickness of the transparent soft resin becomes thicker as it becomes closer to the tip portion, and it is possible to manufacture a lens having a high scratch resistance especially at the tip of it.

The summary of the invention does not necessarily describe all necessary features of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an example of the configuration of a transmission screen 500.

FIG. 2 is an enlarged cross-sectional view exemplary showing the configuration of layers of a Fresnel lens sheet 100.

FIG. 3 is an enlarged cross-sectional view exemplary showing the configuration of layers of a fly-eye lens sheet 200.

FIG. 4 is an enlarged cross-sectional view showing another example of the configuration of layers of a Fresnel lens sheet 100.

FIG. 5 shows a first process of manufacturing the Fresnel lens sheet 100.

FIG. 6 shows a second process of manufacturing the Fresnel lens sheet 100.

FIG. 7 shows a third process of manufacturing the Fresnel lens sheet 100.

FIG. 8 shows a fourth process of manufacturing the Fresnel lens sheet 100.

FIG. 9 shows a fifth process of manufacturing the Fresnel lens sheet 100.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

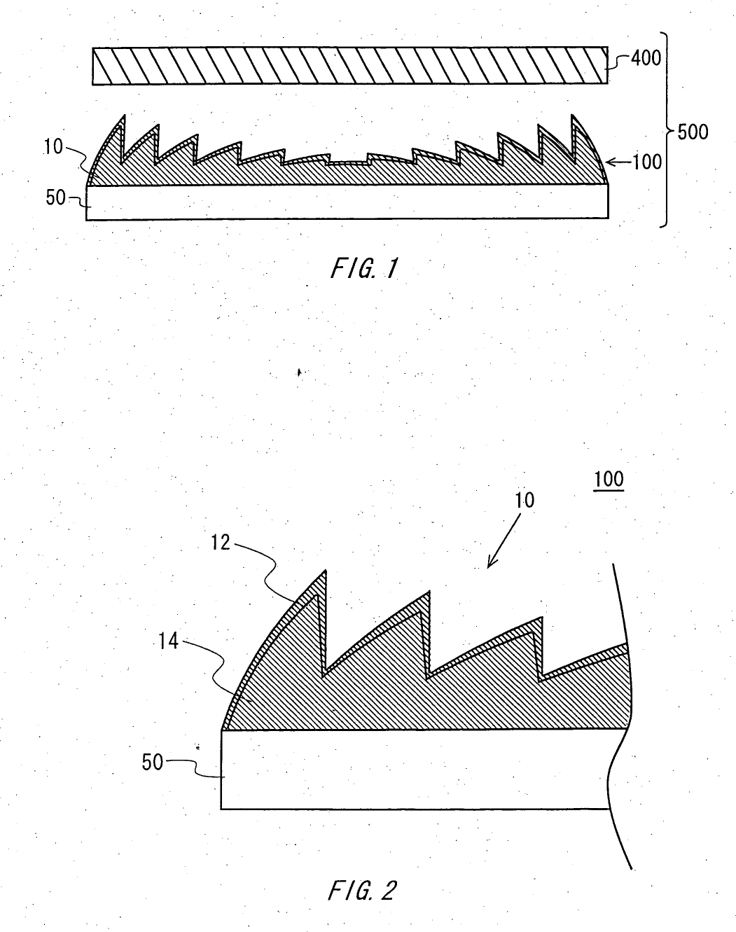

FIG. 1 shows an example of the configuration of a transmission screen 500. The transmission screen 500 has a plurality of light-transmitting members, which are substantially parallel to each other and lie near or adjacent to each other. The plurality of light-transmitting members are, for example, a Fresnel lens sheet 100 for refracting light and another optical member 400. The optical member 400 may be one of a lenticular lens sheet, a fly-eye lens sheet, a diffuser, a polarizer, a retarder, and the like, according to use of the transmission screen 500.

The Fresnel lens sheet 100 is an example of the lens of the present and includes a Fresnel lens layer 10 which has a plurality of protrusions and cavities for refracting light and a substrate 50 which has tabular shape and is made of s a light-transmitting material. The substrate 50 makes the Fresnel lens layer 10 easier to handle by fixing the Fresnel lens layer 10, which has the plurality of protrusions and cavities, directly thereon. The Fresnel lens sheet 100 is assembled so that the Fresnel lens layer 10 faces to the optical member 400. The word “tabular” used herein simply refers to the shape of the substrate 50. The substrate 50 may be a flexible film or sheet. In order to diffuse light, the substrate 50 may have finely rough or satin-finished surface thereof. Alternatively, in order to diffuse light, the substrate 50 may contain light dispersing agents.

FIG. 2 is a cross-sectional view exemplary showing the configuration of layers of the Fresnel lens sheet 100. The cross section is provided by cutting out the Fresnel lens sheet 100 by a plane passing the optical axis of the Fresnel lens sheet 100. The Fresnel lens layer 10 includes a core layer 14 and a skin layer 12. The core layer 14 has a cross sectional shape which is smaller than and its cross sectional shape is similar to the cross sectional shape of the lens. The skin layer 12 covers the core layer. The substrate fixes the core layer 14 directly on a surface thereof.

The core layer 14 is made of hard and transparent resin. The skin layer 12 is made of transparent resin having the same index of refraction as that of the core layer 14 and the smaller storage modulus of elasticity than that of the core layer 14. Therefore, the Fresnel lens layer 14 is durable against damage and has high shape stability because the cross-sectional shape of the core layer 14 is substantially similar to that of the lens. Thus, the transmission screen 500 can refract pixel light to be displayed with high accuracy and display an image of good quality.

Here, the storage modules of elasticity of the skin layer 12 and the core layer are measured as follows:

Measuring Tool: Dynamic viscoelasticity Measuring Apparatus (DMA)

Measuring Method: tensile measurement

Temperature Increasing Rate: 3° C./Min.

Tensile Rate: 1 Hz.

Measured Temperature Range: −20˜80° C.

Reading Method: Read storage modulus of elasticity (E′) at each temperature

The thickness of the skin layer 12 is substantially the same as that of a vertex of the lens in the direction perpendicular to the bottom surface of the lens.

Thus, it is possible to protect preferentially a part of the Fresnel lens layer 10, which is easy to contact with another member.

Alternatively, the thickness of the skin layer 12 is substantially uniform in a direction perpendicular to a bottom surface of the lens. In this case, an impact applied to the Fresnel lens layer 10 in the direction perpendicular to the substrate 50 can be absorbed uniformly over the whole surface of the Fresnel lens layer 10. Thus, the core layer 14 can be protected uniformly over the whole surface.

The cross sectional shape of each of the core layer 14 and the skin layer 12 is wedge-shaped, and a vertical angle of the cross-sectional shape of the core layer 14 which is away from the substrate 50 is greater than that of the skin layer 12. Thus, it is possible to enhance the shape stability of the lens because the area of the lens occupied by the core layer 14 becomes larger at the part of the core layer nearer to the bottom surface of the lens.

Further, it is preferable that the height of the core layer 14 is greater than a half of the total height of the lens. Thus, it is possible to ensure the shape stability of the lens.

Here, the storage modulus of elasticity of the optical member 400 described with reference to FIG. 1 is at least equal to or greater than that of the skin layer 12. Alternatively, the glass transition point of the skin layer 12 is equal to or less than that of the optical member 400. Thus, even in case the optical member 400 contacts with the Fresnel lens layer 10 during assembling or conveying the transmission screen 500, the Fresnel lens layer 10 can be protected by a buffer effect of the skin layer 12 and is not easily damaged.

Further, the core layer 14 and the skin layer 12 are made of, for example, urethane acrylate which is ultraviolet curable resin. In this case, in order to make the Fresnel lens layer 10 have high shape stability and not easily damaged at the same time, it is preferable to put the Fresnel lens layer 10 within a predetermined temperature range. In particular, in case a probability of the Fresnel lens layer 10 contacting with another member is high, for example, during assembling or conveying the transmission screen 500, it is preferable to use the Fresnel lens layer 10 within a range from 15° C. to 40° C. At a temperature below 15° C., the skin layer 12 becomes harder and more brittle. At a temperature above 40° C., the storage modules of elasticity of the core layer 14 and the skin layer 12 become lower and easier to be damaged in case of contacting with another member.

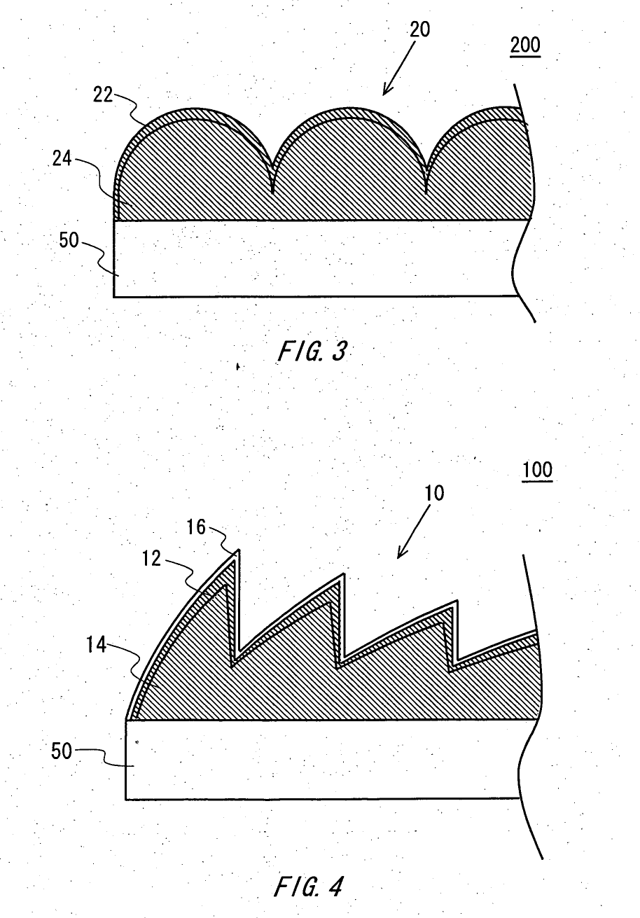

FIG. 3 shows an example of the configuration of layers of a fly-eye lens sheet 200 which is another example of the lens of the present invention. With regard to the following embodiment, an explanation is omitted on the same member as that of the embodiment described above. The fly-eye lens sheet 200 includes a plurality of micro lens unit cell disposed lengthwise and crosswise, that is, in a plane. The fly-eye lens sheet 200 includes a fly-eye lens layer 20 and a substrate 50. The fly-eye lens sheet 200 includes a core layer 24 and a skin layer 22. The core layer 24 corresponds to the core layer 14 of the Fresnel lens sheet 100. Since characteristics of the core layer 24 and the skin layer 22 are the same as those of the core layer 14 and the skin layer 12, respectively, description thereof is omitted. The transmission screen 500 described with reference to FIG. 1 may have the fly-eye lens sheet 200 instead of the Fresnel lens sheet 100. Alternatively, the transmission screen 500 may have the fly-eye lens sheet 200 instead of the optical member 400.

Since the size of the micro lens unit cell is very small, a lens function of the micro lens unit cell is easily damaged in case the micro lens array collides with another member. In particular, in case the fly-eye lens includes the plurality of micro lens unit cell disposed lengthwise and crosswise, that is, in a plane, each micro lens unit cell refracts pixel light incident upon the micro lens unit cell. Therefore, it is impossible to refract properly the light incident upon the micro lens unit cell if the micro lens unit cell is damaged. Here, the fly-eye lens sheet 200 of the present embodiment is not easily damaged and has a high shape stability by including the core layer 24 and the skin layer 22. Therefore, the transmitting screen 500 can refract pixel light to be displayed with high accuracy and display an image of good quality.

FIG. 4 shows another example of the configuration of layers of the Fresnel lens sheet 100. The Fresnel lens sheet 100 of the present embodiment may further include another resin layer on a surface of the skin layer 12. In this case, the resin layer may have a function different from that of the core layer 14 and the skin layer 12. For example, the skin layer 12 may have an anti-reflection layer (AR layer) 16 on a surface thereof. The anti-reflection layer 16 transmits light incident onto the Fresnel lens layer 10 from the lower side of the figure, that is, the side of the substrate 50 almost without attenuating the light, and prevents light incident from the upper side of the FIG. 4, that is, from the side of the Fresnel lens layer 10 from being reflected. Thus, the anti-reflection layer 16 improves visibility of image light which is incident from the side of the substrate 50 and emitted from the side of the Fresnel lens layer 10.

Here, the thickness of the anti-reflection layer 16 of the present embodiment is substantially uniform in a direction perpendicular to the bottom surface of the lens. Alternatively, the thickness of the anti-reflection layer 16 may be substantially uniform in a direction perpendicular to the surface of the lens. According to a conventional Fresnel lens sheet on which an anti-reflection layer is formed, the anti-reflection layer is especially thick at a dent of the lens. For this reason, there is a problem that light incident onto the part where the anti-reflection layer is especially thick is not properly refracted. In the meantime, the Fresnel lens sheet 100 of the present embodiment has the anti-reflection layer 16 of uniform thickness. Thus, it is possible to properly refract the light incident onto the Fresnel lens 100, over the whole of the Fresnel lens sheet 100. A method for manufacturing the anti-reflection layer 16 will be described later.

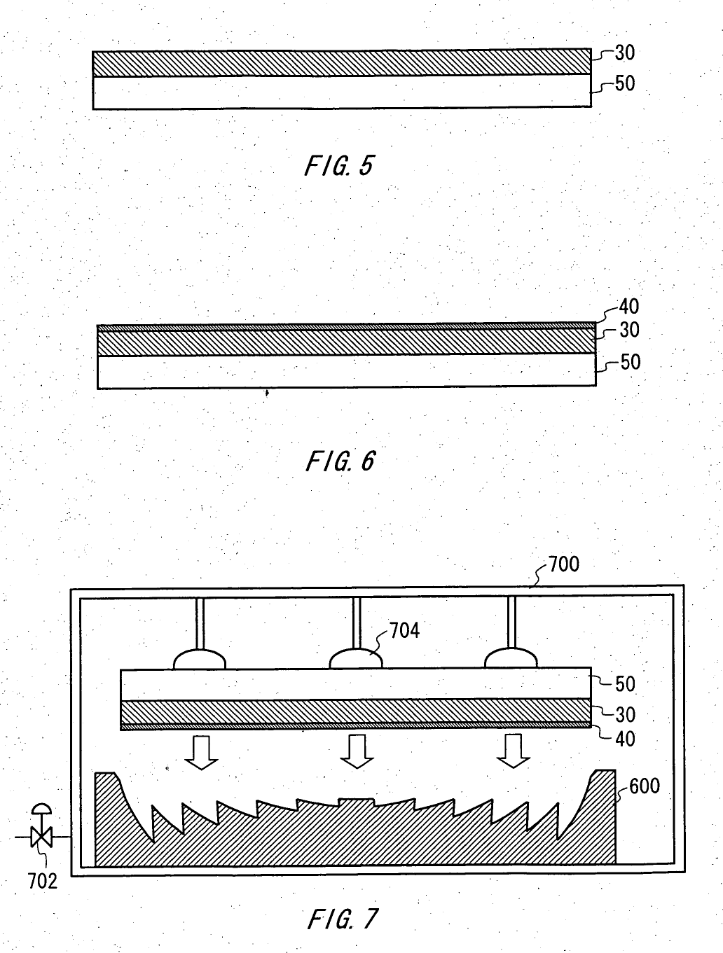

In the following, a method for manufacturing the Fresnel lens sheet 100 will be explained. FIG. 5 shows a first process of manufacturing the Fresnel lens sheet 100. First, the substrate 50, which has tabular shape and is transparent material, is prepared. The substrate 50 is made of styrene-based resin such as methacrylate styrene (MS), polycarbonate, polyethylene terephthalate (PET), and the like. Further, an uncured hard transparent resinhard transparent resin 30 is uniformly formed on the substrate 50. The thickness of the hard transparent resinhard transparent resin 30 is substantially 150 μm. In case of manufacturing the fly-eye lens sheet 200, the thickness of the hard transparent resinhard transparent resin 30 is substantially 30 μm.

The hard transparent resinhard transparent resin 30 is, for example, transparent ultraviolet curable resin (2P resin) such as urethane acrylate resin. Generally, the uncured ultraviolet curable resin has two states, i.e., a fluid state of having high fluidity and a state of having high viscosity and constant shape stability. In the present embodiment, the uncured hard transparent resinhard transparent resin 30 has the latter. For example, the hard transparent resinhard transparent resin 30 is transparent ultraviolet curable resin and prepared in a form of an adhesive sheet. The shape stability of the uncured hard transparent resinhard transparent resin 30 can be adjusted by, for example, the rate of an organic solvent included in the hard transparent resinhard transparent resin 30. If the rate of an organic solvent increases, the shape stability of the hard transparent resinhard transparent resin 30 declines. The organic solvent is, for example, ethyl acetate, methyl ethyl ketone, and toluene. In case the rate of the organic solvent included in the hard transparent resin 30 is too much, it brings about problems that the hard transparent resin 30 lacks the shape stability, the substrate 50 is dissolved or swells so that its shape is distorted, and light transmittance declines because white turbid remains after being cured. Therefore, the rate of the organic solvent included in the hard transparent resin 30 or an transparent soft resin 40 needs to be an amount required for filling the hard transparent resin 30 or the transparent soft resin 40 properly into a mold in a third process described later. In case of urethane acrylate, the hard transparent resin 30 is prepared as a grade satisfying the properties after curing as follows:

E′ (storage modulus of elasticity)=500˜1500 MPa (15° C.˜40° C.)

Tan δ (tangent of loss)=0.03˜0.15 (15° C.˜40° C., 1 Hz, measured at each temperature)

Tg (glass transition temperature)=40° C.˜60° C.

Further, Tan δ=E″/E′ (E′: storage modulus of elasticity, E″: loss modulus of elasticity) shows easiness and difficulty to be restored. For example, the resin becomes easier to be restored and more durable against damage as the value of Tan δ becomes larger. Tg is a temperature at which Tan δ has a peak value and shows hardness of the resin.

FIG. 6 shows a second process of manufacturing the Fresnel lens sheet 100. During the process, the transparent soft resin 40, of which storage modulus is smaller in a cured state than that of the hard transparent resin 30, is formed substantially uniformly in an uncured state on the upper surface of the hard transparent resin 30. At this time, the transparent soft resin 40 is thinner than the hard transparent resin 30. The thickness of the transparent soft resin 40 is, for example, one to three micrometers.

The transparent soft resin 40 is transparent ultraviolet curable resin such as urethane acrylate resin and prepared in a form of an adhesive sheet. In case of urethane acrylate resin, the transparent soft resin 40 is prepared with the grade satisfying the properties after curing as follows:

E′ (storage modulus of elasticity)=5˜500 MPa (15° C.˜40° C.)

Tan δ (tangent of loss)=0.2˜1.2 (15° C.˜40° C., 1 Hz, measured at each temperature)

Tg (glass transition temperature)=15° C.˜30°

Further, the measurement conditions are the same as the hard transparent resin 30.

FIG. 7 shows a third process of manufacturing the Fresnel lens sheet 100. During this process, the uncured transparent hard resin 30 and soft resin 40 are filled in a mold 600 by compression molding. A mold 600 for forming the Fresnel lens layer 10 is disposed with its cavity facing upwards in a vacuum chamber 700. First, the substrate 50 on which the uncured transparent hard resin 30 and soft resin 40 are formed is put into the vacuum chamber 700. At this time, the chuck 704 provided in the vacuum chamber 700 holds the substrate 50 so that the transparent hard resin 30 and soft resin 40 are opposed to the cavity of the mold 600. Further, it is preferable to heat the transparent hard resin 30 and soft resin 40 through the substrate 50 by heating the chuck 704. It is preferable that the temperature of the transparent hard resin 30 and soft resin 40 is substantially 20° C. to 40° C. At a temperature below 20° C., the storage modules of the transparent hard resin 30 and soft resin 40 become higher and it becomes more difficult to fill the transparent hard resin 30 and soft resin 40 in a mold. At a temperature above 40° C., it becomes more difficult to fill the transparent hard resin 30 and soft resin 40 in a mold because the organic solvent included in the transparent hard resin 30 and soft resin 40 is volatilized and the transparent hard resin 30 and soft resin 40 becomes harder. Then, a reducing valve 702 reduces the inside pressure of the vacuum chamber 700. When the inside pressure of the vacuum chamber 700 is sufficiently reduced, the chuck 704 puts down the transparent soft resin 40 on the mold 600.

Then, pressure is applied uniformly on the whole surface of the substrate 50 at a time. For example, an airbag may apply pressure on the whole surface of the substrate 50 at a time. Conditions of applying pressure and heating are, for example, 0.5 MPa, 40° C., and 120 seconds. In addition, the means for applying pressure may be a roll lamination method and a press method using oil pressure and the like. In the roll lamination method, the transparent hard resin 30 and soft resin 40 may be heated to the above mentioned temperature by heating a roll. During this process, the uncured transparent hard resin 30 and soft resin 40 are pressed against the mold 600. At this time, the transparent hard resin 30 and soft resin 40 are filled completely in the whole of the cavity of the mold 600 without including bubbles because ambient pressure is reduced.

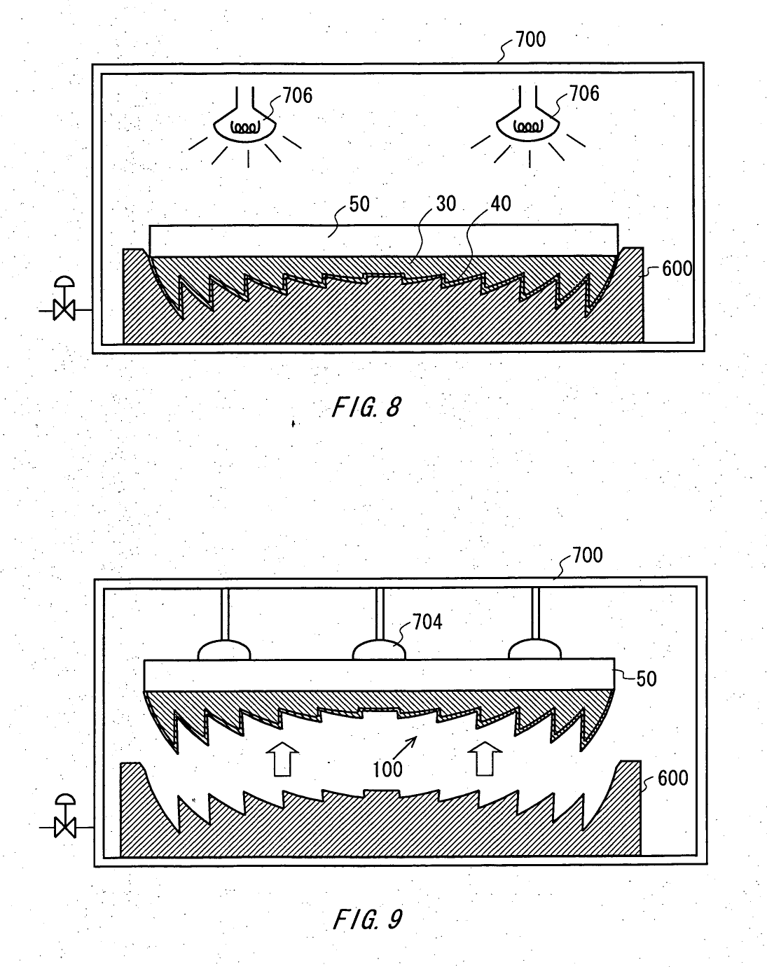

FIG. 8 shows a fourth process of manufacturing the Fresnel lens sheet 100. During this process, the transparent hard resin 30 and soft resin 40 are cured. The vacuum chamber 700 has an infrared lamp on the upper surface. The ultraviolet lamp 706 irradiates the transparent hard resin 30 and soft resin 40 with ultraviolet rays from above the substrate 50. By this, the transparent hard resin 30 and soft resin 40 are cured. After transparent hard resin 30 and soft resin 40 are irradiated for enough time to be cured by the ultraviolet lamp 706, the inside pressure of the vacuum chamber 700 returns to the atmospheric pressure by opening the reducing valve 702. The hard transparent resin 30 becomes the core layer 14 after the curing, and the transparent soft resin 40 becomes the skin layer 12 after the curing.

FIG. 9 shows a fifth process of manufacturing the Fresnel lens sheet 100. In this process, the substrate 50 is pulled upward by the chuck 704. By this, the cured transparent hard resin 30 and soft resin 40 are released from the mold 600. The Fresnel lens sheet 100 is manufactured through the above described processes.

According to the above manufacturing method, so called a compression molding, the mold structure is simpler and easier to control the manufacturing temperature and pressure than the conventional injection molding or transfer molding which uses thermoplastic or thermosetting resins. According to the Fresnel lens sheet 100 of the present embodiment, it is possible to easily form the core layer 14 and the skin layer 12 through the compression molding by forming the uncured transparent hard resin 30 and soft resin 40 on the substrate, respectively. Therefore, productivity of the Fresnel lens is increased.

Further, it is also possible to easily form a substantially uniform skin layer 12 by performing the compression molding on the transparent hard resin 30 and soft resin 40 formed substantially uniformly in advance in vacuum.

Further, it is possible to form the core layer 14 to be a major portion of the lens after curing by forming the transparent soft resin 40 to be thinner than the hard transparent resin 30. Therefore, it is possible to manufacture a lens of a high scratch resistance and shape stability.

Further, it is preferable to adjust the loss modules of rigidities of the uncured transparent hard resin 30 and soft resin 40 in order that the loss modulus of rigidity of the uncured transparent soft resin 40 is greater than that of the uncured hard transparent resin 30 in the manufacturing method described with reference to FIG. 6. By this, the transparent soft resin layer 40 is hard to be varied in its thickness by a shearing force from the mold 600 during the forming process of the hard transparent resin 30 according to the shape of cavity of the mold 600 in mold pressing. Therefore, the transparent soft resin 40 is formed to have a substantially uniform thickness. The loss modules of rigidities of the uncured transparent hard resin 30 and soft resin 40 are adjusted by rates of organic solvents included in the uncured transparent hard resin 30 and soft resin 40. For example, in order to decrease the loss modules of rigidities of the uncured transparent hard resin 30 and soft resin 40, it is good to increase the rates of organic solvents included in the uncured transparent hard resin 30 and soft resin 40. In the manufacturing method according to the present embodiment, the loss modules of rigidities of the uncured transparent hard resin 30 and soft resin 40 are adjusted to be in following range:

The Uncured Hard Transparent Resin 30;

The loss modulus of rigidity (G″)=0.007 MPa˜0.01 MPa

The Uncured Transparent Soft Resin 40;

The loss modulus of rigidity (G″)=0.01 MPa˜0.02 MPa

Here, the loss modules of rigidities of the uncured transparent hard resin 30 and soft resin 40 are measured as follows:

Measuring Tool: A dynamic viscoelasticity Measuring Apparatus (DMA)

Measuring Method: Shear Measurement

Temperature Increasing Rate: 3° C./Min.

Shear Rate: 1 Hz

Measured Temperature Range: 30˜80° C.

Reading Method: Read loss modulus of rigidity at each temperature

Alternatively, it is also preferable to adjust the loss modules of rigidities of the uncured transparent hard resin 30 and soft resin 40 in order that the loss modulus of rigidity of the uncured transparent soft resin 40 is smaller than that of the uncured hard transparent resin 30. For example, the loss modules of rigidities of the uncured transparent hard resin 30 and soft resin 40 are adjusted to be in following range:

The Uncured Hard Transparent Resin 30;

The loss modulus of rigidity (G″)=0.01 MPa˜0.02 MPa

The Uncured Transparent Soft Resin 40;

The loss modulus of rigidity (G″)=0.007 MPa˜0.01 MPa

In this case, the transparent soft resin layer 40 is easy to be varied in its thickness by a shearing force from the mold 600 during the forming process of the hard transparent resin 30 according to the shape of cavity of the mold 600 in mold pressing. For example, the thickness of the bottom portion, which receives the largest shearing force from the mold, the transparent soft resin 40 becomes the thinnest, and the closer to the tip portion, which does not receive the shearing force from the mold, of the transparent soft resin 40, the thicker the thickness of it becomes. As a result, the thickness of the transparent soft resin 40 becomes thicker at closer to the tip portion.

Further, according to the present embodiment, it is possible to depress enough and necessary amount of the transparent hard resin 30 and soft resin 40 for forming the lens in the mold 600 by controlling the thickness of the transparent hard resin 30 and soft resin 40 formed on the substrate 50. Therefore, the transparent hard resin 30 and soft resin 40 are not flowed out of the mold 600 in mold pressing, and the conventional removing step of removing excessive resin from the mold is not required.

Further, only the hard transparent resin 30 may be filled in the mold 600 by omitting the second step described with reference to FIG. 6. By this, it is possible to make a single-layered lens including only a hard core layer more effectively than the conventional method.

Alternatively, another additional resin layer may be formed on the uncured transparent soft resin layer 40 substantially uniformly after the second step described with reference to FIG. 6. By this, it is possible to form still another resin layer of a substantially uniform thickness on the surface of the skin layer 12. For example, it is possible to form an anti-reflection layer 16 shown in FIG. 4 on the surface of the Fresnel lens substantially uniformly by forming an AR layer on the uncured transparent soft resin 40. In this case, it is possible to prevent polar resin from being pooled on a dent portion of the lens by forming the AR layer through conventional dipping. In other words, according to the present embodiment, it is possible to form the anti-reflection layer 16 substantially uniformly. By this, it is possible to acquire a substantially uniform optical characteristic throughout the whole portion of the lens.

As described above, according to the present embodiment, it is possible to achieve a lens of both high shape stability and high scratch resistance.

Although the present invention has been described by way of exemplary embodiments, it should be understood that those skilled in the art might make many changes and substitutions without departing from the spirit and the scope of the present invention which is defined only by the appended claims.

1. A lens which has a plurality of protrusions and cavities comprising:
a core layer having a cross sectional shape smaller than and similar to a cross sectional shape of said lens; and
a skin layer, which covers said core layer, having a smaller storage modulus of elasticity than that of said core layer.

2. A lens as claimed in claim 1, further comprising a substrate for fixing said core layer on a surface thereof, said substrate having tabular shape and being made of a light-transmitting material.

3. A lens as claimed in claim 1, wherein thickness of said skin layer is substantially uniform in a direction perpendicular to a bottom surface of said lens.

4. A lens as claimed in claim 1, wherein thickness of said skin layer is substantially thicker at closer to a vertex of said lens in a direction perpendicular to a bottom surface of said lens.

5. A lens as claimed in claim 1, wherein the cross sectional shape of said core and skin layers is wedge-shaped, and a vertical angle of the wedge-shaped cross section of said core layer is greater than that of said skin layer.

6. A lens as claimed in claim 1, wherein said lens is a micro lens array comprising a plurality of micro lens unit cell.

7. A lens as claimed in claim 6, wherein said lens is a fly-eye lens comprising a plurality of micro lens unit cell disposed in a plane.

8. A lens as claimed in claim 1, wherein the height of said core layer is equal to or greater than a half of the total height of said lens.

9. A light-transmitting screen comprising:
a lens which has a plurality of protrusions and cavities; and
an optical member provided to face the plurality of protrusions and cavities on said lens,
wherein said lens comprises;
a core layer having a cross sectional shape smaller than and similar to a cross sectional shape of said lens; and
a skin layer, which covers said core layer, having a smaller storage modulus of elasticity than that of said core layer, and
a storage modulus of elasticity of said optical member is greater than that of said skin layer.

10. A method for manufacturing a lens of which a plurality of protrusions and cavities are formed, comprising:
a resin layer forming step of substantially uniformly forming an uncured transparent resin of a predetermined thickness on a light-transmitting substrate having tabular shape;
a filling step of filling the transparent resin into a mold by pressing the uncured transparent resin layer on the mold of the lens;
a curing step of curing the transparent resin filled in the mold; and
a releasing step of releasing the cured resin from the mold.

11. A method for manufacturing a lens as claimed in claim 10, further comprising a pressure reducing step of reducing ambient pressure of the mold before said filling step.

12. A method for manufacturing a lens as claimed in claim 10, wherein
an uncured ultraviolet curable resin is formed to have a predetermined thickness substantially uniformly on the substrate in said resin layer forming step, and
the ultraviolet curable resin filled in the mold is cured by ultraviolet ray irradiation thereto in said curing step.

13. A method for manufacturing a lens as claimed in claim 10, further comprising:
a soft resin layer forming step of substantially uniformly forming an uncured transparent soft resin layer of a predetermined thickness on the upper surface of the uncured transparent resin, the soft resin layer having a storage modulus of elasticity in cured status smaller than that of the transparent resin, between said resin layer forming step and filling step.

14. A method for manufacturing a lens as claimed in claim 13, wherein the soft resin is formed to be thinner than the transparent resin in said soft resin layer forming step.

15. A method for manufacturing a lens as claimed in claim 13, further comprising a step of providing the uncured transparent resin and the uncured transparent soft resin so that a loss modulus of rigidity of the uncured transparent soft resin is greater than that of the uncured transparent resin, before said soft resin layer forming step.

16. A method for manufacturing a lens as claimed in claim 13, further comprising a step of providing the uncured transparent resin and the uncured transparent soft resin so that a loss modulus of rigidity of the uncured transparent soft resin is smaller than that of the uncured transparent resin, before said soft resin layer forming step.
